(19) United States
(12) Patent Application Publication
(10) Pub. No.: US 2008/0073622 A1
(43) Pub. Date: Mar. 27, 2008

(54) Conductive polyurethane foam and methods for making same

(75) Inventor: Tyler Housel, Lansdale, PA (US)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Inolex Investment Corporation, Wilmington, DE (US)

(21) Appl. No.: 11/717,377

(22) Filed: Mar. 12, 2007

Related U.S. Application Data
(60) Provisional application No. 60/846,710, filed on Sep. 22, 2006.

(51) Int. Cl. H01B 1/12

(52) U.S. Cl. 252/519.34; 252/500; 252/519.33; 521/137

(57) ABSTRACT

A conductive polyurethane foam and a method of manufacturing a conductive polyurethane foam is described. The conductive polyurethane foam is produced using a polyurethane foam formulation and a conductive component that has at least one organic compound, at least one a metal salt and/or combinations thereof.

### CROSS REFERENCE TO RELATED APPLICATIONS

This application claims the benefit under 35 U.S.C. 119(e) of U.S. Provisional Application No. 60/846,710, filed Sep. 22, 2006.

### BACKGROUND OF THE INVENTION

1. Field of the Invention

The present invention relates to the field of conductive polyurethane foams and methods of manufacturing conductive polyurethane foams.

2. Description of Related Art

Polyurethane foam is formed from the reaction of various polyisocyanates and polyols in the presence of water and/or possibly other blowing agents to provide the gas that fills the cells. Approximately 80-99% of a typical polyurethane foam formulation consists of the polyisocyanate, polyol and water starting components. These major components react together to make foam by forming a gas phase and a solid polyurethane phase. Typically, both phases are electrically insulative.

It is known to use additives to impart some degree of electrical conductivity to solid polyurethane polymers, however technologies developed to date have had limited success and typically involve numerous post-processing operations. For example, methods have been developed to make use of conductive quasi-solutions of transition metal salts dispersed in a carrier solution using a dispersing agent. These solutions are used to make conductive single-phase polyurethanes. While numerous metal salts are useful and effective as charge carriers, they require 70% or more of a polyol or flame retardant and up to 5% of a dispersant such as a non-ionic surfactant. Such methods are sufficient for a single-phase polyurethane, but in a two-phase, foamed polyurethane, the charge carriers are significantly more spread out since the solid polyurethane phase is typically less than about 10 percent of the volume of the foam. Moreover additional polyols, flame-retardants, and dispersants in the quasi-solution are likely to interfere with the delicate balance of a foamed system. At best the metal charge carriers are delivered at 30% actives.

Conductive polyurethane foams are also know to be made using a post-treatment wherein a solvent swells the foam and allows conductive chemicals to interpenetrate the polyurethane. After the solvent is removed, the chemicals remain in the polymer. While this can be effective, it involves extra processing steps and uses solvents that can cause significant regulatory concerns.

Still other conductive polyurethane foams have been made using a post treatment where the cells are coated with a solvent solution or ink of conductive material. Again, these techniques involve extra processing steps and solvents that significantly reduce their desirability.

Another technology for making conductive polyurethane foams is to add conductive solid fillers such as carbon or metals to the foam formulation. However, in all cases, the particles of solid fillers must be added at a high enough concentration that an electrically conductive pathway is formed within the polymer phase. This requires high particle loadings and adds significant difficulties to the foaming process because it necessitates continuous adding, mixing and handling of solid materials.

The use of charge transfer agents as additives in foam formulations have also been shown effective in forming a conductive polyurethane foam. Such chemical additives shown to be effective are picric acid, tetracyanoethylene, tetracyanoquinodimethane and sodium perchlorate. Unfortunately, many of these chemicals are potentially explosive or highly toxic which makes them particularly hazardous and dangerous to handle.

Methods for making liquid conductive materials involve the use of ionic solvent systems of metal salts and amine salts that give low melting points. The methods can be used with electrodeposition, electroplating, battery electrolytes, extractions, metal recovery, and electropolishing technologies or as a solvent or catalyst for chemical reactions.

As such there is still a need for better conductive properties in electrically conductive polyurethane and for an improved method of manufacturing conductive polyurethane foam that is simple (e.g., formed in a one-step process using liquid additives), economical, and provides enhanced electrical conductivity to the resulting foam. Further, there is a desire in the foam industry for an easy way to improve electrical conductivity in polyurethane foams. Often, the goal is static dissipation. Some target markets are military, aerospace, printing, and electronic cleanrooms.

### BRIEF SUMMARY OF THE INVENTION

The present invention is directed to conductive polyurethane foam and methods of manufacturing conductive polyurethane foam. The foam is formed from a foam formulation that includes a conductive component which has one or more conductive materials. The foam formulation may also include standard components such as catalysts, foam additives and solvents to obtain desired properties and reactions. The present invention further is able to provide for a single-step method of manufacturing conductive polyurethane foam that does not require multiple post-foam forming processes to impart conductivity to the foam.

The invention includes a formulation for forming a conductive polyurethane foam. The formulation comprises a polyurethane foam formulation and a conductive component that comprises at least one of: an organic compound, a metal salt and combinations thereof, wherein the polyurethane foam formulation comprises at least one polyisocyanate, at least one polyol and water, wherein the polyurethane foam formulation comprises about 2 to about 5 parts by weight of the water per hundred parts by weight of the at least one polyol.

The invention also includes a method of making a conductive polyurethane foam. The method comprises (a) providing a conductive component which comprises at least one of: an organic compound, a metal salt and combinations thereof, (b) preparing a polyurethane foam formulation comprising foam-forming components and the conductive component, and (c) preparing a conductive polyurethane foam by reacting the foam-forming components in the polyurethane foam formulation comprising the conductive component, wherein the polyurethane foam formulation comprises: at least one polyisocyanate; at least one polyol; and water.

The invention further includes a formulation for forming a conductive polyurethane foam which comprises a polyurethane foam formulation and a conductive component comprising at least one of: an organic compound, a metal salt and combinations thereof, wherein the foam formulation comprises at least one polyisocyanate, at least one polyol and water, wherein the polyurethane foam formulation comprises about 5 to about 95 parts by weight of the at least one polyol per 100 parts by weight of the polyurethane foam formulation and at least one of the at least one polyol has an acid number of at least about 5 mg KOH/g.

The invention also includes a method of making a conductive polyurethane foam. The method comprises (a) providing a conductive component which comprises at least one of: an organic compound, a metal salt and combinations thereof, (b) preparing a polyurethane foam formulation comprising foam-forming components and the conductive component, and (c) preparing a conductive polyurethane foam by reacting the foam-forming components in the polyurethane foam formulation comprising the conductive component, wherein the polyurethane foam formulation foam-forming components comprise at least one polyisocyanate, at least one polyol and water, and wherein the polyurethane foam formulation comprises about 5 to about 95 parts by weight of the at least one polyol per 100 parts by weight of the polyurethane foam formulation and at least one of the at least one polyol has an acid number of at least about 5 mg KOH/g, wherein the formulation comprises about 2 to about 5 parts by weight of the water per 100 parts by weight of the at least one polyol, and wherein the conductive polyurethane foam has a density of about 20 to about 60 kg/m³ and has a surface resistivity of less than about 1×10¹¹ ohms per square.

### DETAILED DESCRIPTION OF THE INVENTION

The present invention is related to conductive polyurethane foam. In an embodiment, the present invention provides for a liquid, electrically conductive, ionic or non-ionic mixture of conductive components i.e., a conductive mixture that can be added to a polyurethane foam formulation to produce an electrically conductive polyurethane foam. In another embodiment, the present invention provides for using a conductive component alone to produce a conductive polyurethane foam. Disclosed are methods for making such foams.

The conductive component(s), whether used singly or in combinations, such as mixtures, can be provided to any conventional polyurethane foam formulation having a polyol as described herein. A detailed description of the polyurethane foam formulation and methods of manufacturing polyurethane foams is generally not necessary for a complete understanding of the invention by one of ordinary skill in the art. However, for illustrative purposes only, a typical polyurethane foam formulation will be described herein.

The polyurethane foam formulation includes at least one polymeric polyol and at least one organic isocyanate that react together in the presence of water. These three components preferably combine and simultaneously form an organic polymer skeleton and gas phase in a one-step process. However, it should be understood based on this disclosure that two-step or other polyurethane forming reactions may be used. The polyurethane foam formulation may be stabilized by a silicone or various organic surfactants. Catalysts are preferably used to control the rates of the various simultaneous reactions that occur during the foam forming process. Other additives can also be added to improve aesthetic, functional, or other properties of the finished foam. These additives, for example, can include colorants, crosslinkers, plasticizers, fillers, flame-retardants, or other emulsifiers and surfactants, UV absorbers, other conductive agents and the like to impart specific properties. Such additives are typically added in an amount of a few percent by weight, however some additives can be added up to about 20% by weight.

The polyols are usually the largest component by weight in a polyurethane formulation. Polyols typically used may be about 1,000 to about 6,000 molecular weight polymers that preferably average between 2 and 4 reactive hydroxyl groups per molecule. Commercial polyols are generally based on repeating ester or ether units. Thus, preferred are polyester polyols and polyether polyols. Polyols based on other repeat structures are known and may be used as well.

Polyols typically used to prepare polyurethane foam formulation have negligible acidity as represented by a titration acid value of less than 2 mg KOH/g sample. However, special polyols with a higher acid value do exist. For example, commercial polyester polyols with high acid values are Lexorez® 1105-HV2 and Lexorez® 1405-65, having acid values of about 20 and about 60 mg KOH/g respectively both from Inolex Chemical Company of Philadelphia, Pa. These polyols with high acid values are used in the claimed invention and allow a lower electrical resistivity and increased stability of the foam. However, it should be understood, that an overall “acid” contribution from the polyol(s), i.e., the overall “polyol component”, is useful in the formulation, but it is not necessary that each of the polyols used has a high acid number to provide a good formulation. In other words, one strong acid polyol in combination with a non-acidic polyol can provide the acid content preferred. The overall polyol component is present in the formulation preferably in an amount of about 5 to about 95 parts by weight per 100 parts by weight of the polyurethane foam formulation. However, while a high acid number polyol is preferred, it should be understood from this disclosure that a variety of polyols may be used and/or the acid content varied in combination with the amount and type of the conductive component to achieve desired properties.

Polyester polyols typically used are made from diethylene glycol and adipic acid with additional functionality being imparted from small levels of glycerin, trimethylol propane or other monomeric polyols. These polyester polyols have a hydroxyl value of about 50 to about 60 and a hydroxyl functionality of about 2.4 to about 3.0. A commercial example is Lexorez® 1102-SOFT from Inolex Chemical Company.

Polyether polyols used are typically copolymerized from ethylene oxide and propylene oxide using a monomeric diol or polyol as an initiator.

All polyurethanes of the present invention are made with reactive polyisocyanates. The majority are aromatic polyisocyanates, broadly classified as toluene diisocyanate (TDI) types and methylene diphenyl diisocyanate (MDI) types. The preferred isocyanate is TDI. There are primarily two isomers of TDI, the 2,6 isomer and the 2,4 isomer. The 2,6 isomer has two isocyanate groups ortho to the methyl group on a toluene ring. The 2,4 isomer has an isocyanate ortho and another para to the methyl group. Processes for manufacturing TDI always make a combination of the 2,4 and 2,6 isomers while little isocyanate is formed at the meta site. Therefore, other isomers such as 2,3 TDI, 3,4 TDI and 3,5 TDI are present in insignificant quantities. Two types of TDI are typically manufactured for foam use, TDI-80 and TDI-65. TDI-80 has about 80% of the 2,4 isomer and TDI-65 has only about 65% of the 2,4 isomer. In both cases, the remainder is the 2,6 isomer. None of the isocyanate types are electrically conductive. Isocyanates and other conventional polyurethane foam components can be used in accordance with conventional polyurethane foam formulation amounts.

The conductive polyurethane foams of the present invention can be made from aromatic isocyanates such as toluene diisocyanate (TDI) as a reactive ingredient, and water as the primary blowing agent. The amount of isocyanate for such foams should be approximately stoichiometric such that the total number of isocyanate groups per unit mass are within about 15% of the total amount of reactive hydroxyl, water, and amine groups in the same per unit mass.

Water can be added to all polyurethane foam formulations. Water reacts with isocyanate groups to produce carbon dioxide (CO₂). The CO₂ gas fills the cells and foams the reacting mixture. Water in the polyurethane foam formulation reacts with isocyanate and may no longer be present after the reaction is complete.

Foam formulations may also contain additional blowing agents that volatilize using the exothermic heat of reaction. Such blowing agents are typically low boiling liquids such as fluorocarbons, chlorofluorocarbons, hydrofluorocarbons, hydrochlorocarbons, acetone, cyclopentane, pentane, and the like. These agents are low molecular weight molecules designed to evaporate at a low temperature. To attain the necessary ease of evaporation, they do not contain ionic or other groups that could potentially contribute to electrical conductivity.

Once all the liquid ingredients are mixed together, all reactions must proceed at the correct rates in order to produce suitable foam. In the foaming formulation, both polyol(s) and water are vying to react with the available isocyanate groups. When the isocyanate reacts with water it produces the carbon dioxide gas that fills the cells. This is called the blowing reaction. When the isocyanate reacts with the hydroxyl groups from the polyol(s), it increases the average molecular weight, leading to higher viscosity, gelation and finally polymer strength. This is called the gel reaction. Since these reactions occur simultaneously, the rates must also be controlled relative to each other. For example, if the blow reaction goes too fast, the gas will bubble out of the foam before it is elastic enough to expand. In this extreme case, the foam bun will collapse on itself. Catalysts are used to control each of these reactions. Normally tin or other metal catalysts primarily promote the gel reaction. Amine catalysts can be used to promote either the gel or blowing reaction depending on the specific chemical structure. Although, catalytic ingredients have some electrical conductivity, in a typical polyurethane foam formulation, they are not added at sufficient concentrations to effectively impart conductivity on the final foam article.

During the manufacturing process of polyurethane foams, liquid reactants are mixed together and bubbles form in the liquid. As the reaction proceeds, the bubbles grow and the molecular weight of the polymer increases, so that it eventually becomes a matrix of polymer surrounding cavities filled with gas. The final foam is stabilized by the crosslinked polymer structure, but while the reactants are still liquid, a surfactant is used to stabilize the bubbles and prevent them from coalescing. The surfactant forms nucleation sites that will become the bubbles. Additional additives to a foam formulation can be added such that they do not interfere with the nucleation and stabilization roles of the surfactant.

Two types of surfactant are preferably used to make polyurethane foams. These are silicone types and organic types, depending on whether the chemical structure is based on polysiloxanes. Both types are typically blends of subcomponents that have various emulsification and cell stabilization functions. These emulsification and stabilization properties work with the specific polyol(s), polyisocyanate, and additives in the foam formulation. However, other various surfactants known in the art are applicable to the present invention. Although surfactants can contain ionic or other conductive groups, they are generally not added in sufficient concentration to make the foam electrically conductive.

To attain various properties, additives are used to modify foam formulations. Such additives include those mentioned above, such as, for example, flame-retardants, colorants, crosslinkers, antimicrobials, fillers, light stabilizers, antioxidants, and the like.

The invention includes methods for making conductive polyurethane foam as well. To make conductive polyurethane foam according to the invention, a conductive component which is at least one of an organic compound, a metal salt and combinations thereof is provided to a polyurethane form formulation. The conductive component may be a liquid, electrically conductive ionic or non-ionic compound or mixture, i.e., a conductive organic compound or mixture of such compounds alone or a metal salt or mixture of such salts can be used, as can various combinations, including mixtures of organic compounds and metal salts as described herein. The conductive component is added to a polyurethane foam formulation which is then reacted using foam forming reactions to form a conductive polyurethane foam. The foam formulation may be any conventional polyurethane foam formulation known in the art or to be developed, including those as described herein.

In one embodiment of a conductive polyurethane foam according to the invention, a conductive component, including combinations thereof, including preferred mixtures of conductive components is used which is/are compatible with the delicate balance of reactions and surface chemistry used in polyurethane foam forming. Experimentation has established that conductive metal salts and/or certain organic compounds may be used to create a conductive component, including a liquid mixture that is highly efficient at enhancing the electrical conductivity of polyurethane foam. These liquid mixtures can be highly polar, ionic, or non-ionic liquids or deep eutectic solvents, i.e., a type of ionic solvent with special properties composed of a mixture which forms a eutectic with a melting point much lower than either of the individual components.

In one embodiment, a combination of conductive components can be formed, including a preferred mixture which can be a binary mixture or higher order mixtures of organic compounds and metal salts that melt at or below about 60° C. such that the mixture can be handled as a liquid when added to a formulation for conductive polyurethane foam. The mixture can include at least one organic compound and one metal salt. Preferably, the mixture of organic compound and metal salt is such that the mixture is in a liquid state at about 35° C. If a metal salt or organic ionic compound is used alone, it can be a liquid additive, or it can be a solid that is dissolved into the polyester so the overall combination of conductive components and polyester polyol(s) is a liquid. Examples of preferred combinations of conductive components are represented in Example 1-19.

The present invention also includes a conductive polyurethane foam which has a conductive component combined with the foam formulation. Experimentation has found that some organic compounds, including quaternary ammonium salts (ionic compounds) give great conductivity by themselves without the need for the metal salt as part of the conductive component to be added to the formulation. Further, experimentation has found that some metal salts give excellent conductivity properties by themselves without the need for an organic compound when combined with the polyurethane foam formulation. Organic compounds and metal salts that can be used independently include the same components which may be used in combinations in accordance with the above-noted embodiment of the invention described herein. Preferred examples of foams using a single conductive component are represented in Table 6 as Examples 20-27. Preferred examples of foams using a single conductive component with a catalyst are represented in Table 8 as Examples 28-38.

Examples of each embodiment as discussed above are included herein for understanding various preferred uses and combinations of each embodiment for providing a conductive component and polyurethane foam formulation combination herein, some have catalysts and additives, to obtain conductive polyurethane foams with specific properties as desired. As can be seen from the examples herein, each conductive polyurethane foam of the present invention is unique in that it has a low density of about 20 to about 60 kg/m, preferably has a relatively high acid number and includes a high concentration of a conductive component such as a metal salt and/or organic/ionic compounds. These characteristics translate into stable and commercially desirable polyurethane conductive foams.

In all of the embodiments of the present invention, whether based on a combination of metal salts and/or organic/ionic compounds, or based upon these materials used independently, water can be added to the conductive component in an amount of up to about 10 percent by weight of the conductive component to lower viscosity and improve fluidity. Preferably, the conductive component includes no greater than about 5 percent by weight water. Water can help restore the water of hydration that can be lost as the mixture is heated during preparation. The total water added to the polyurethane foam formulation, including that which may be present in the conductive component, should be about 2 and about 5 parts by weight, and preferably about 2 to about 4 parts by weight per 100 parts by weight of the total polyol component.

As used herein, “organic compounds” useful for conductive components can be a neutral compound(s) or an ionic compound(s) such as an ionic liquid or a compound based upon a salt of an organic compound.

Examples of salts of an organic compound useful herein can be quaternary ammonium salts of the general form R₄—N⁺—X⁻, quaternary phosponium salts R₄—P⁺—X⁻ or tertiary sulfonium salts R₃—S⁺—X⁻ where R₄—N⁺ is a quaternary ammonium moiety such as a tetraalkylammonium, alkylimidazolium, alkylpyridinium, alkylpyrazolium, alkyltriazolium, alkylthiazolium, and alkylpyrazinium. While the “R” groups or “alkyl” examples are given, it should be understood that alkenyl, alkynyl, aryl, aralkyl and other organic salts are also contemplated herein as well as branched and straight chain structures. Such organic moieties can also be further substituted with various groups, for example, alkyl; aryl; any further substituted alkyl; hydroxyl; acetyl; carboxyl; alkoxy such as methoxy, and ethoxy; phenol; methylol; ethylol; or halogen. X⁻ represents a counter ion such as, for example, chloride, bromide, iodide, acetate, ethylhexanoate, acetoacetate, sulfate, iodate, phosphate, carbonate, acrylate, methacrylate, nitrate, formate, cholinate, methanesulfonate, methylsulfate, ethylsulfate, hydrogensulfate, tetrachloroaluminate, thiocyanate, salicylate, and pentanedioate.

Other suitable organic compounds useful herein include, for example, choline chloride, choline bromide, choline bicarbonate, betaine, betaine hydrochloride, betaine aldehyde chloride, benzyl trimethylammonium chloride, (3-chloro-2-hydroxypropyl) trimethylammonium chloride, glycidyltrimethylammonium chloride, (2-aminoethyl) trimethylammonium chloride, (3-carboxypropyl)trimethylammonium chloride, 1-ethyl-3-methylimidazolium hydrogensulfate, 1-butyl-3-methylimidazolium hexafluorophosphate, methylimidazolium chloride, 1-ethyl-3-methylimidazolium ethylsulfate, carboxymethyl trimethylammonium bromide, carbamylcholine chloride, acetylcholine chloride, carboxymethyl trimethylammonium chloride, betaine, betaine hydrochloride, (2-chloroethyl)trimethylammonium chloride, L-carnitine inner salt, and L-carnitine hydrochloride. Many of these organic compounds are available as solids that form a eutectic mixture when combined with metal salts. Others are liquids, in which case, they are known as ionic liquids.

A most preferred organic compound of the present embodiment is choline chloride, which forms mixtures with a number of compounds that have unexpectedly low melting points.

Neutral or non-ionic organic compounds which combine with transition metal salts to produce conductive liquids are highly polar materials such as low molecular weight cyclic or non-cyclic amides or borates. Borate solvent systems are described in U.S. Pat. No. 5,849,532, the disclosure of which is hereby incorporated by reference in relevant part. Non-ionic organic compounds of the present embodiment include N-methyl-pyrrolidinone and N—N-dimethyl formamide. The semi-quantitative solubility of many inorganic compounds in dimethyl formamide and solubilities of inorganic compounds in N-methyl-pyrrolidinone are readily known in the art.

The metal salts which may be used as or in conductive components according to the present invention are preferably transition metal salts. Metals of atomic weight at least about 20 are preferred, particularly if the metal is in a higher oxidation state.

Of the various metal salts which can be used in either a mixture with an organic compound in the polyurethane foam formulation or in a polyurethane foam formulation which does not include an ionic liquid, include potassium salts, and in particular potassium iodide, which form valuable conductive foams when dissolved directly with the formulation, as described in Tables 6 and 8 herein.

Further, it is within the scope of the present invention to provide a polyurethane foam formulation having enhanced electrical conductivity that includes any conventional polyurethane foam formulation as described in any of the above embodiments and a liquid mixture having one or more metal salts in a carrier solvent that is highly polar, ionic, or a deep eutectic.

Metal salts for use herein include copper (oxidation state I or II), iron (II or III), cobalt (II or III), nickel (II), silver (I), gold (III), potassium (I), zinc (II), manganese (II or III), cadmium (II), magnesium (II), chromium (II or III), zirconium (II, III or IV), and calcium (II).

The percent by weight metal salt used in a mixture is not limited to any particular range. Preferably, the metal salts if used in the conductive component contribute about 0.01% to 15% metallic ions to the total polyurethane foam formulation. While the amount of metal salt can vary, the preferred percent by weight metal salt in the mixture is such that the resulting polyurethane foam has improved conductivity properties and more preferably is at least about 30% by weight metal salt, and even more preferably at least about 50% by weight metal salt.

The counter anion of the present embodiment can be organic or inorganic. The counter anion associates with the metal cation such that the metal salt can form liquid compositions having sufficient charge carrying ability to enhance the electrical conductivity of polyurethane foam. Counter anions of the present embodiment include chloride, bromide, iodide, acetate, ethylhexanoate, acetoacetate, sulfate, iodate, phosphate, carbonate, acrylate, methacrylate, nitrate, formate, cholinate, perchlorate, methanesulfonate, methylsulfate, ethylsulfate, hydrogensulfate, tetrachloroaluminate, cyanate, thiocyanate, salicylate, and pentanedioate.

Low melting ionic liquids of the present invention are commercially available and include Catasail, manufactured by Sachem Incorporated, and Cobaline 200, Cromline 190, Zicline 200, and Zinline 200, manufactured by Scionix Ltd. of London, UK.

The solid polymeric phase of the conductive foam manufactured according to the present invention is mostly comprised of an organic polymeric polyol and an organic polyisocyanate. The conductive component, whether formed of a combination of materials or a single material, advantageously enhances the electrical conductivity regardless of the type of polyol(s) used with conventional foam formulations. Moreover, surprisingly the liquid, electrically conductive ionic or non-ionic mixture provides for exceptional results when used with a polyol or polyol combination, wherein at least one of the polyol(s) used has a preferred high acid number of at least about 5 mg KOH/g and even more so with polyol(s) used alone or in combination which have an acid number of at least about 10 mg KOH/g although as noted elsewhere herein the acid content can be varied and/or met in a variety of ways. Preferably the polyurethane foam formulations include about 5 to about 95 parts by weight of the overall polyol components per 100 parts by weight of the polyurethane foam formulation, and more preferably about 25 to about 75 parts by weight.

Polyurethane foams of the present invention preferably include about 0.01% to about 15% of the total metallic ion content derived from metal salts from the conductive component if metal salts are used. The foam formulations preferably include about 0.2 to about 10 parts by weight of the conductive component per 100 parts by weight of the polyol component in the foam formulation. Resulting polyurethane foams also preferably have an electrical surface resistivity of less than about 10¹¹ ohms per square.

Polyurethane foams of the present invention preferably include one or more interfacially active agents or surface active agents to emulsify the ingredients and stabilize the cellular structure before the polymer builds sufficient molecular weight to support itself. Preferably, the surfactant should contain separate ingredients for stabilization and emulsification. Many different foam stabilizers are readily known and commercially available, as such a detailed description of them is not necessary for a complete understanding of the invention.

Other optional ingredients known or to be developed in the polyurethane arts for imparting specific performance properties can be included in the conductive foam of the present embodiment. These include colorants, flame-retardants, fungicides, bactericides, plasticizers, crosslinking polyols, diamines, antioxidants, and so on. These additives are readily known in the art and a detailed description of them is not necessary for a complete understanding of the invention.

The invention will now be further described in accordance with the following non-limiting Examples.

### EXAMPLES 1-9

The following examples illustrate embodiments wherein the conductive component includes a combination of materials for forming conductive polyurethane foams as well as to illustrate methods of making such conductive polyurethane foams.

Various liquid, electrically conductive, ionic or non-ionic mixtures were prepared according to the methods described below.

Mixture Example 1: A mixture of 25 grams of copper (II) acetate monohydrate (product CXCU010, Gelest Chemicals, Inc., Morrisville, Pa.) and 50 grams of choline chloride (product C1879, Aldrich Chemicals, Milwaukee, Wis.) were heated to 147° C. and mixed by agitation. The combination remained liquid as the mixture was cooled to room temperature.

Mixture Example 2: A mixture of 20 grams of copper (II) acetate monohydrate and 30 grams of choline chloride were heated to 155° C. and mixed by agitation. The combination remained liquid as the mixture was cooled to room temperature.

Mixture Example 3: A mixture of 25 grams of copper (II) acetate monohydrate and 25 grams of choline chloride were heated to 155° C. and mixed by agitation. The combination remained liquid as the mixture was cooled to room temperature.

Mixture Example 4: A mixture of 2 grams of copper (II) chloride dihydrate (product 221783, Aldrich Chemicals) and 1 gram of choline chloride were heated to 80° C. The resulting mixture was solid at room temperature, but liquid at 60° C. Adding 0.3 grams of water (10%) made the mixture liquid at room temperature.

Mixture Example 5: Mixtures of copper (II) chloride dihydrate and choline chloride were produced at ratios between 2:1 and 1:2. All were solid at room temperature but liquid at 60° C. All mixtures remained liquid at room temperature upon adding 10% water.

Mixture Example 6: A mixture of 30 grams of copper (II) chloride dihydrate and 45 grams of N-methylpyrrolidinone (product 03688, Fischer Scientific, Fair Lawn, N.J.) were mixed at room temperature and formed a uniform liquid solution.

Mixture Example 7: A mixture of 2 grams of iron (III) chloride hexahydrate (product F2877, Aldrich Chemicals) and 2 grams of dimethyl formamide (product D133, Fischer Scientific) were mixed at room temperature and formed a uniform liquid solution.

Mixture Example 8: A mixture of 2 grams of copper (II) nitrate hydrate (product 223395, Aldrich Chemicals) and 2 grams of dimethyl formamide were mixed at room temperature and formed a uniform liquid solution.

Mixture Example 9: A mixture of 1 gram of copper (II) chloride dihydrate and 2 grams of dimethyl formamide were mixed at room temperature and formed a uniform liquid solution.

Various polyurethane foam samples were prepared using the mixtures as described above and the following low acid value base formulation (Base Formula 1) and high acid value base formulation (Base Formula 2) shown below in Table 1.

TABLE 1

| | Amount | | Function |
|---|---|---|---|
| Base Formula 1-Low | | | |
| acid value polyol | | | |
| Lexorez ® 1102-50FT | 100 | grams | Polyol reactant |
| Water | 4 | grams | Reactant |
| Tolylene 2,4 diisocyanate | 48 | grams | Isocyanate reactant |
| Jeffcat ZF-10: (N,N,N′-trimethyl- | 0.5 | grams | Catalyst |
| N′-hydroxyethyl- | | | |
| bisaminoethylether) | | | |
| Dabco DC4000 polyether modified | 1 | gram | Surfactant |
| polysiloxane | | | |
| Base Formula 2-High | | | |
| acid value polyol | | | |
| Lexorez ® 1105-HV2 | 100 | grams | Polyol reactant |
| Water | 4 | grams | Reactant |
| Tolylene 2,4 diisocyanate | 48 | grams | Isocyanate reactant |
| Urea | 1 | gram | Catalyst |
| Tegostab B8301 | 1 | gram | Surfactant |

### EXAMPLES 10-19

The foam specimens of Examples 11-13 and 15-19 were produced in a laboratory setting using some of the various mixtures and Base Formulations described above. Example 11 was prepared using a 1:1.5 ratio as noted in Table 2 based on Mixture Example 5. Examples 12 and 18 were prepared using Mixture Example 7. In Example 12, however 1.89 grams of the Example 7 mixture were used per 100 g polyol in Base Formula 1 while Example 18 included 1.95 g per 100 g polyol in Base Formula 2. Examples 13 and 17 were prepared using Mixture Example 1. Example 15 was prepared using Mixture Example 6. Example 16 was prepared from Mixture Example 5 having the ratio noted in Table 2. Example 18 was prepared using Mixture Example 7. Comparative Examples 10 and 14 were made as described below from the two Base Formulas but without any conductive mixture added to the polyurethane foam formulation. The appropriate amount of polyol reactant and isocyanate reactant were measured gravimetrically and placed within a plastic cup. The reactants were then mixed slowly until homogeneous. Afterwards, the mixture of conductive components was added, followed by a blend of water, catalyst and surfactant. These ingredients were then mixed quickly and the mixture poured into a square box to rise and cure. After several hours, the foam was cut and tested. This technique is typical for bench scale simulation of the commercial foaming process.

The following foam samples were produced and measured for electrical resistivity as described in Tables 2 and 3.

TABLE 2

| | Base | | | | |
|---|---|---|---|---|---|
| | Formula | Polyol | | | |
| | (from | acid | | Organic | Wt |
| Examples | Table 1) | value | Metal salt | compound | ratio |
| Comparative | 1 | Low | None | — | — |
| Example 10 | | | | | |
| Example 11 | 1 | Low | Copper (II) | Choline chloride | 1:1.5 |
| | | | chloride | | |
| Example 12 | 1 | Low | Iron (III) | Dimethyl | 1:1 |
| | | | chloride | formamide | |
| Example 13 | 1 | Low | Copper (II) | Choline chloride | 1:2 |
| | | | acetate | | |
| Comparative | 2 | High | None | — | — |
| Example 14 | | | | | |
| Example 15 | 2 | High | Copper (II) | Methyl | 1:1.5 |
| | | | chloride | pyrrolidinone | |
| Example 16 | 2 | High | Copper (II) | Choline chloride | 1:1 |
| | | | chloride | | |
| Example 17 | 2 | High | Copper (II) | Choline chloride | 1:2 |
| | | | acetate | | |
| Example 18 | 2 | High | Iron (III) | Dimethyl | 1:1 |
| | | | chloride | formamide | |
| Example 19 | 2 | High | Copper (II) | Choline chloride | 1:1 |
| | | | acetate | | |

TABLE 3

| | Amt | | | |
|---|---|---|---|---|
| | (g/100 g | Foam density | Foam resistivity | Improvement |
| Examples | polyol) | (kg/m³) | (×10⁹ Ω/sq) | vs. control |
| Comparative | 0 | 31 | 11,000 | — |
| Example10 | | | | |
| Example 11 | 0.91 | 51 | 210 | 52x |
| Example 12 | 1.89 | 80 | 450 | 24x |
| Example 13 | 1.33 | 24 | 263 | 42x |
| Comparative | 0 | 31 | 170 | — |
| Example 14 | | | | |
| Example 15 | 1.31 | 31 | 3.6 | 47x |
| Example 16 | 0.91 | 32 | 4.9 | 35x |
| Example 17 | 1.26 | 29 | 12.5 | 14x |
| Example 18 | 1.95 | 32 | 11.3 | 15x |
| Example 19 | 4.12 | 34 | 8.9 | 19x |

The surface resistivities of foam samples based on Comparative Examples 10 and 14 and Examples 11-13 and 15-19 were measured by Electro-Tech Systems Inc. of Glenside, Pa. using ASTM D-257 with a test voltage of 100V and an ETS Series 800 concentric ring probe. The foam samples were preconditioned at 75° F. and 50% relative humidity (RH) for 48 hours as specified by National Fire Protection Association (NFPA) 99 protocols.

The results in Tables 2 and 3 above show that the conductive polyurethane foam produced according to the invention wherein a mixture of materials to form a conductive component was used have significantly reduced electrical surface resistivity. Further, the electrical surface resistivity is significantly lower when using a high acid value polyester polyol such as Lexorez® 1105-HV2 in comparison to a low acid value polyester polyol.

### EXAMPLES 20-27

The following Examples describe conductive components having a single material for preparation of an electrically conductive foam. Examples 10-19 establish that Lexorez® 1105-HV2 (an acid functional polyester polyol) functions to maximize conductivity. As shown in Tables 4 and 7, this polyol is used in the remainder of the Examples, 20-38.

The following Examples showed that a single material, conductive component is compatible with the foam system and improves conductivity. Table 4 lists the basic formulation to be used with each conductive component listed in Table 5. All were added at 0.5 parts per hundred except copper acetate which was added at 0.25 parts per hundred in Table 6.

TABLE 4
BASIC FORMULATION FOR EXAMPLES 20–27

| Ingredient | Amount |
|---|---|
| Lexorez ® 1105-HV2 (Acid | 100 |
| number 20) | |
| Water | 4.0 |
| Surfactant: Niax SE-232 | 1.0 |
| Additives | 0.5 |
| TDI-75 | 47.25 [100] |
| Target density | 2.4 pcf (about 45 kg/m³) |

TABLE 5
CONDUCTIVE ADDITIVES

| Code | Name | Manufacturer | Type |
|---|---|---|---|
| FeCl₃ | Ferric chloride | Aldrich | Inorganic transition salt |
| | hexahydrate | | |
| CuAc₂ | Copper acetate | Gelest | Organic transition salt |
| KNO₃ | Potassium nitrate | Aldrich | Salt |
| KI | Potassium iodide | Alfa Aesar | Salt |
| AC39 | Basionic AC-39 | BASF/Aldrich | Ionic liquid-1-methyl |
| | | | imidazolium hydrogen |
| | | | sulfate |
| LQ01 | Basionic LQ-01 | BASF/Aldrich | Ionic liquid-1-ethyl-3- |
| | | | methylimidazolium ethyl |
| | | | sulfate |
| ST35 | Basionic ST-35 | BASF/Aldrich | Ionic liquid-1-ethyl-3- |
| | | | methylimidazolium |
| | | | methanesulfonate |
| Marisail | Marisail | Sachem | Ionic liquid-proprietary |
| Terrasail | Terrasail | Sachem | Ionic liquid-proprietary |

Resistivity was measured with the Ohm Stat RT-1000 meter from Static Solutions Inc. The meter reads resistivity in ohm/sq as well as relative humidity and temperature. The results are illustrated below in Table 6. Target density was achieved for each Example; it should be recognized that density may vary slightly depending on fluctuations in temperature and atmospheric pressure.

TABLE 6
RESISTIVITY OHM/SQ AT 74° F. AND
46% RELATIVE HUMIDITY

| | | Resistivity | Improvement |
|---|---|---|---|
| Examples | Additive | (×10⁹ ohm/sq) | over control |
| | Control | 63.9 | — |
| Example 20 | CuAc₂ | 78.2 | — |
| Example21 | Marisail | 4.77 | 13 |
| Example 22 | FeCl₃ | 3.73 | 17 |
| Example 23 | KI | 3.61 | 18 |
| Example 24 | LQ-01 | 3.38 | 19 |
| Example 25 | ST-35 | 3.20 | 20 |
| Example 26 | AC-39 | 3.11 | 21 |
| Example 27 | KNO₃ | 2.80 | 23 |

This data shows a 20-fold improvement between the controls and the foams with ionic liquids or potassium salts. The quality of each of the foams prepared with the additives in Table 6 is an improvement over currently available foams.

### EXAMPLES 28-38

The inclusion of a catalyst further improves the processing and foam quality of the formulations. For the following series of Examples (Examples 28-38), 1.0 part by weight of urea is included as a catalyst.

TABLE 7
FORMULATION FOR TESTING KI AND ILS

| Ingredient | Amount |
|---|---|
| Lexorez ® 1105-HV2 | 100 |
| Water | 4.0 |
| Surfactant: Niax SE-232 | 1.0 |
| Catalyst: urea | 1.0 |
| Conductive additives | 1.0 to 5.0 |
| TDI-75 | 47.25 [100] |

The ionic liquids are already liquid at room temperature. Because liquid additives are preferred, potassium iodide (KI) was added as a solution of KI in DMF (dimethyl formamide) at a 2:5 ratio. Each of the liquid additives was then dissolved into Lexorez® 1105-HV2.

TABLE 8
RESISTIVITY OHM/SQ AT 77° F. AND
40% RELATIVE HUMIDITY

| | | | | Resistivity | Improvement |
|---|---|---|---|---|---|
| Examples | Additive | Amount | | (×10⁹ ohm/sq) | over control |
| | Control | | | 53.1 | |
| Example 28 | Terrasail | 1 | pph | 16.3 | 3 |
| Example 29 | KI-DMF | 0.3 | pph KI | 6.66 | 8 |
| Example 30 | Terrasail | 5 | pph | 4.33 | 12 |
| Example 31 | Marisail | 1 | pph | 2.90 | 18 |
| Example 32 | ST-35 | 1 | pph | 2.33 | 23 |
| Example 33 | LQ-01 | 1 | pph | 2.17 | 24 |
| Example 34 | AC-39 | 1 | pph | 2.03 | 26 |
| Example 35 | KI-DMF | 1.4 | pph KI | 1.55 | 34 |
| Example 36 | Marisail | 5 | pph | 0.613 | 87 |
| Example 37 | ST-35 | 5 | pph | 0.353 | 150 |
| Example 38 | LQ-01 | 5 | pph | 0.272 | 195 |

These foams appear to be improved over currently known commercially available foams used in the art. As can been appreciated by the results in Table 8, additives showing promising results are those including KI and the organic ionic liquids. KI was added as a solution in DMF, so the foam with a 5% additive level actually contained 1.4% of the active ingredient. At this concentration, there was a 30-fold improvement in conductivity. The ionic liquids yielded more than a 100-fold improvement in conductivity at a loading of 5% with no apparent negative effects.

As illustrated, the foams of the present invention have a high electrical conductivity, are easy to formulate and do not discolor. Further, the additives are less toxic and less corrosive than others known in the art. Potassium iodide is also highly effective at improving conductivity, and is not particularly toxic or corrosive. Previously, it was understood by those skilled in the art that the solid KI would require a solvent or other component to make it a liquid, but results herein have established that KI can be dissolved directly into the acid functional polyester (see Example 23).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A formulation for forming a conductive polyurethane foam, comprising:
a polyurethane foam formulation and a conductive component which comprises at least one of: an organic compound, a metal salt, and combinations thereof, wherein the polyurethane foam formulation comprises at least one polyisocyanate, at least one polyol and water, wherein the polyurethane foam formulation comprises about 2 to about 5 parts by weight of the water per hundred parts by weight of the at least one polyol.

2. The formulation of claim 1, wherein the polyurethane foam formulation comprises about 5 to about 95 parts by weight of the at least one polyol per 100 parts by weight of the polyurethane foam formulation and at least one of the at least one polyol has an acid number of at least about 5 mg KOH/g.

3. The formulation of claim 2, wherein the polyurethane foam formulation comprises about 25 to about 75 parts by weight of the at least one polyol and at least one of the at least one polyol has an acid number of at least about 10 mg KOH/g.

4. The formulation of claim 1, wherein the formulation is capable of forming a conductive polyurethane foam having a density of about 20 to about 60 kg/m³.

5. The formulation of claim 1, wherein the formulation is capable of forming a conductive polyurethane foam having a surface resistivity of less than about 1×10¹¹ ohms per square.

6. The formulation of claim 1, wherein the conductive component comprises a metal salt and the metal salt includes at least one metal cation and at least one non-metal anion.

7. The formulation of claim 6, wherein the non-metal anion is selected from the group consisting of chloride, bromide, iodide, acetate, ethylhexanoate, acetoacetate, sulfate, iodate, phosphate, carbonate, acrylate, methacrylate, nitrate, formate, cholinate, hydroxide, methanesulfonate, methylsulfate, ethylsulfate, hydrogensulfate, tetrachloroaluminate, cyanate, thiocyanate, salicylate, pentanedioate, and hydroxide.

8. The formulation of claim 6, wherein the metal cation in the metal salt has an atomic weight of at least about 20.

9. The formulation of claim 6, wherein the metal cation in the metal salt is selected from the group consisting of iron, copper, potassium, zinc, cobalt, nickel, manganese, silver, chromium, and combinations thereof.

10. The formulation of claim 1, wherein the conductive component comprises at least one metal salt selected from the group consisting of copper (II) chloride, copper (II) bromide, copper (II) acetate, copper (II) nitrate, copper (II) iodide, copper (II) hydroxide, iron (III) chloride, iron (III) bromide, iron (III) nitrate, iron (III) iodide, iron (III) hydroxide, and iron (III) acetate.

11. The formulation of claim 1, wherein the conductive component comprises a mixture of metal salts and the mixtures are selected from the group consisting of iron (III) chloride and choline chloride; copper (II) acetate and choline chloride; copper (II) chloride and choline chloride; cobalt (II) chloride and choline chloride; chromium (II) chloride and choline chloride; zinc (II) chloride and choline chloride; zinc (II) nitrate and choline chloride; iron (III) chloride and dimethyl formamide; copper (II) nitrate and dimethyl formamide; copper (II) chloride and dimethyl formamide; copper (II) chloride and methylpyrrolidinone; iron (III) chloride and betaine; iron (III) chloride and betaine hydrochloride; iron (III) chloride and betaine hydrobromide, and iron (III) chloride and betaine hydroiodide.

12. The formulation of claim 1, wherein the conductive component is in a liquid state at about 35° C.

13. The formulation of claim 1, wherein the conductive component comprises a mixture formed by a reaction of the organic compound and the metal salt in a liquid state at about 60° C.

14. The formulation of claim 1, wherein the conductive component comprises the organic compound and the organic compound is at least one of a cyclic polar amide, a non-cyclic polar amide, a cyclic polar borate, and a non-cyclic polar borate.

15. The formulation of claim 1, wherein the conductive component comprises the organic compound and the organic compound is dimethyl formamide or methylpyrrolidinone.

16. The formulation of claim 1, wherein the conductive component comprises the organic compound and the organic compound is a quaternary ammonium salt having the general formula R₄N⁻—X⁻, wherein R₄N⁺ represents a cationic quaternary ammonium moiety, quaternary phosponium salt R₄—P⁺—X⁻ or tertiary sulfonium salt R₃—S⁺—X⁻ and X⁻ represents a counter anion.

17. The formulation of claim 16, wherein the cation moiety is substituted or unsubstituted and selected from the group consisting of tetraalkylammonium, alkylimidazolium, alkylpyridinium, alkylpyrazolium, alkyltriazolium, alkylthiazolium, alkylpyrazinium, imidazolium, dialkylimidazolium, trialkylimidazolium, tetraalkyl phosphonium, trialkyl sulfonium, choline, and betaine.

18. The formulation of claim 16, wherein the R or alkyl groups in the cation moiety may have a substituted group selected from the group consisting of alkyl, aryl, hydroxyl, acetyl, carboxyl, alkoxy, phenol, methylol, ethylol, halogen, and combinations thereof.

19. The formulation of claim 16, wherein the counter anion is selected from the group consisting of chloride, bromide, iodide, acetate, ethylhexanoate, acetoacetate, sulfate, iodate, phosphate, carbonate, acrylate, methacrylate, nitrate, formate, cholinate, methanesulfonate, methylsulfate, ethylsulfate, hydrogensulfate, tetrachloroaluminate, thiocyanate, salicylate, pentanedioate, and combinations thereof.

20. The formulation of claim 1, wherein the conductive component comprises the organic compound and the organic compound is selected from the group consisting of choline chloride, choline bromide, betaine, betaine hydrochloride, betaine hydrobromide, betaine hydroiodide, and combinations thereof.

21. The formulation of claim 1, wherein the conductive component is a mixture which is a deep eutectic solvent.

22. A method of making a conductive polyurethane foam, comprising:
(a) providing a conductive component which comprises at least one of: an organic compound, a metal salt and combinations thereof;
(b) preparing a polyurethane foam formulation comprising foam-forming components and the conductive component; and
(c) preparing a conductive polyurethane foam by reacting the foam-forming components in the polyurethane foam formulation comprising the conductive component, wherein the polyurethane foam formulation comprises:
at least one polyisocyanate;
at least one polyol; and
water.

23. The method of claim 22, wherein the conductive component is a mixture which is in a liquid state at about 35° C.

24. The method of claim 23, wherein the mixture is formed by a reaction of the organic compound and the metal salt in a liquid state at about 60° C.

25. The method of claim 22, wherein the conductive component comprises at least one metal salt and the polyurethane foam formulation comprises about 0.01% to about 15% metallic ions from the at least one metal salt.

26. The method of claim 22, wherein the conductive polyurethane foam has a resistivity of less than about 10¹¹ ohms per square.

27. A formulation for forming a conductive polyurethane foam, comprising: a polyurethane foam formulation and a conductive component which comprises at least one of: an organic compound, a metal salt and combinations thereof, wherein the polyurethane foam formulation comprises at least one polyisocyanate, at least one polyol and water, wherein the polyurethane foam formulation comprises about 5 to about 95 parts by weight of the at least one polyol per 100 parts by weight of the polyurethane foam formulation and at least one of the at least one polyol has an acid number of at least about 5 mg KOH/g.

28. The formulation of claim 27, wherein the polyurethane foam formulation comprises about 2 to about 5 parts by weight of the water per one hundred parts by weight of the at least one polyol, and wherein the formulation is capable of forming a conductive polyurethane foam having a density of about 20 to about 60 kg/m³.

29. The formulation of claim 27, wherein the formulation is capable of forming a conductive polyurethane foam having a surface resistivity of less than about 1×10¹¹ ohms per square.

30. The formulation of claim 27, wherein the polyurethane foam formulation comprises about 25 to about 75 parts by weight of the at least one polyol per 100 parts by weight of the foam formulation and at least one of the at least one polyol has an acid number of at least about 10 mg KOH/g, wherein the polyurethane foam formulation comprises about 2 to about 5 parts by weight of the water per one hundred parts by weight of the at least one polyol, and wherein the formulation is capable of forming a conductive polyurethane foam having a density of about 20 to about 60 kg/m³ and a surface resistivity of less than about 1×10¹¹ ohms per square.

31. The formulation of claim 27, wherein the conductive component is present in the polyurethane foam formulation in an amount of about 0.2 to about 10 parts by weight per hundred parts by weight of the at least one polyol.

32. A method of making a conductive polyurethane foam comprising:
(a) providing a conductive component which comprises at least one of: an organic compound, a metal salt and combinations thereof;
(b) preparing a polyurethane foam formulation comprising foam-forming components and the conductive component; and
(c) preparing a conductive polyurethane foam by reacting the foam-forming components in the polyurethane foam formulation comprising the conductive component, wherein the polyurethane foam formulation foam-forming comprises:
at least one polyisocyanate;
at least one polyol; and
water,
wherein the polyurethane foam formulation comprises about 5 to about 95 parts by weight of the at least one polyol per 100 parts by weight of the polyurethane foam formulation and at least one of the at least one polyol has an acid number of at least about 5 mg KOH/g, wherein the polyurethane foam formulation comprises about 2 to about 5 parts by weight of the water per hundred parts by weight of the at least one polyol, and wherein the conductive polyurethane foam has a density of about 20 to about 60 kg/m³ and a surface resistivity of less than about 1×10¹¹ ohms per square.

33. The method of claim 32, wherein the polyurethane foam formulation comprises about 25 to about 75 parts by weight of the at least one polyol and at least one of the at least one polyol has an acid number of at least 10 mg KOH/g, wherein the polyurethane foam formulation comprises about 2 to about 5 parts by weight of the water per one hundred parts by weight of the at least one polyol, wherein the conductive polyurethane foam has a density of about 20 to about 60 kg/m³ and a surface resistivity of less than about 1×10¹¹ ohms per square.
